(19) United States
(12) Patent Application Publication
(10) Pub. No.: US 2026/0251470 A1
(43) Pub. Date: Aug. 27, 2026

(54) ENHANCING PERCEPTION RANGE OF SURROUND VIEW CAMERAS FOR MULTI-MODAL LEARNING

(71) Applicant: QUALCOMM Incorporated, San Diego, CA (US)

(72) Inventors: Aman Gajendra Jain, Bengaluru (IN); Ashish Garg, Pehowa (IN); Chiranjib Choudhuri, Bangalore (IN); Varun Ravi Kumar, San Diego, CA (US); Senthil Kumar Yogamani, San Diego, CA (US)

(21) Appl. No.: 19/059,520

(22) Filed: Feb. 21, 2025

(51) Int. Cl. G01C 21/36; G06V 10/44; G06V 10/771; G06V 20/56; G06V 20/58

(52) U.S. Cl. CPC G01C 21/3638; G06V 10/44; G06V 10/771; G06V 20/582; G06V 20/584; G06V 20/588

(57) ABSTRACT

A method for enhancing perception range of a computer vision system includes: obtaining a plurality of panoramic pictures related to an intended driving trajectory of a vehicle; converting each of the plurality of panoramic pictures into a plurality of perspective pictures; applying a machine learning model to the plurality of perspective pictures to generate information related to a plurality of static road objects; generating a 3D point cloud corresponding to the intended travel trajectory of the vehicle by performing a 3D reconstruction on the plurality of perspective pictures; extracting, using the 3D point cloud, locations of the plurality of static road objects; and operating a vehicle assistance system, while the vehicle is moving along the intended driving trajectory, based on the information related to the plurality of static road objects and the locations of the plurality of static road objects.

### TECHNICAL FIELD

This disclosure relates to image processing.

### BACKGROUND

Surround view cameras, while a valuable tool for enhancing vehicle safety and convenience, have inherent limitations that may hinder ability of the surround view cameras to perform 3D perception tasks. In autonomous driving, stereo vision is a technique where two cameras, positioned a certain distance apart, capture slightly different views of the same scene. By comparing these two images, an on-board computer may calculate depth information, much like human eyes do. Surround view cameras systems typically use multiple cameras positioned around the vehicle to provide a 360-degree view. However, in many contemporary autonomous driving systems, the surround view cameras are often positioned in a manner which results in minimal overlap between the images captured by different cameras. In some examples, with minimal overlap, there are fewer cues for the autonomous driving system to accurately estimate depth. Furthermore, as objects move farther from the surround view camera, these objects may occupy fewer pixels in the picture. This reduction in pixel density may lead to a loss of fine details at longer range and may degrade the performance of deep learning modules for various downstream tasks like detection, classification, etc.

### SUMMARY

The disclosed techniques may be utilized by an autonomous driving system and/or vehicle assistance system and may include performing pre-driving preparations. The objective of the pre-driving preparation may be to pre-process static information about a route from position A to position B. This pre-processed information may then be used by the vehicle assistance system to more efficiently and accurately estimate various static road objects in real-time. The techniques of this disclosure may include obtaining the coordinates (e.g., Global Positioning System (GPS) coordinates or Global Navigation Satellite System (GNSS) coordinates) of the trajectory from position A to position B. Obtaining the coordinates may be achieved using a variety of methods, including, but not limited to, GPS navigation systems or digital maps. Furthermore, once the coordinates are obtained, the coordinates may be used to query a mapping Application Programming Interface (API), such as Google Street View API, for example. A mapping API may enable the disclosed system to request panoramic pictures of specific locations based on latitude and longitude of the corresponding locations. This disclosure describes techniques for obtaining a collection of panoramic pictures by querying the API for various points along the trajectory. The disclosed techniques may include obtaining pictures that provide a 360-degree view of the environment at each point. To make the panoramic pictures more suitable for computer vision tasks, the panoramic pictures may be transformed into perspective pictures. Panorama decomposition is similar to taking snapshots of various sections of the panorama.

The disclosed techniques may transform perspective pictures to simulate the view from the camera of autonomous driving system at specific points along the route. By pre-processing static information, the vehicle assistance system may focus computational resources on dynamic elements like moving vehicles and pedestrians, while the autonomous driving system is in motion.

In one example, a method for enhancing perception range of a computer vision system includes: obtaining a plurality of panoramic pictures related to an intended driving trajectory of a vehicle; converting each of the plurality of panoramic pictures into a plurality of perspective pictures; applying one or more machine learning models to the plurality of perspective pictures to generate information related to a plurality of static road objects; generating a 3D point cloud corresponding to the intended driving trajectory of the vehicle, including performing a 3D reconstruction on the plurality of perspective pictures; extracting, using the 3D point cloud, locations of the plurality of detected static road objects; and operating a vehicle assistance system, while the vehicle is moving along the intended driving trajectory, based on the information related to the plurality of static road objects and the locations of the plurality of static road objects.

In another example, a system for enhancing perception range of a computer vision system includes a memory for storing a plurality of panoramic pictures; and processing circuitry in communication with the memory. The processing circuitry is configured to obtain the plurality of panoramic pictures related to an intended driving trajectory of a vehicle and convert each of the plurality of panoramic pictures into a plurality of perspective pictures. The processing circuitry is also configured to apply one or more machine learning models to the plurality of perspective pictures to generate information related to a plurality of static road objects and generate a 3D point cloud corresponding to the intended driving trajectory of the vehicle, including performing a 3D reconstruction on the plurality of perspective pictures. The processing circuitry is further configured to extract, using the 3D point cloud, locations of the plurality of detected static road objects; and operate a vehicle assistance system, while the vehicle is moving along the intended driving trajectory, based on the information related to the plurality of static road objects and the locations of the plurality of static road objects.

In yet another example, non-transitory computer-readable storage media having instructions encoded thereon, the instructions configured to cause processing circuitry to: obtain a plurality of panoramic pictures related to an intended driving trajectory of a vehicle and convert each of the plurality of panoramic pictures into a plurality of perspective pictures. Additionally, the instructions are configured to apply one or more machine learning models to the plurality of perspective pictures to generate information related to a plurality of static road objects and generate a 3D point cloud corresponding to the intended driving trajectory of the vehicle, including performing a 3D reconstruction on the plurality of perspective pictures. Furthermore, the instructions are configured to extract, using the 3D point cloud, locations of the plurality of detected static road objects; and operate a vehicle assistance system, while the vehicle is moving along the intended driving trajectory, based on the information related to the plurality of static road objects and the locations of the plurality of static road objects.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example autonomous vehicle, in accordance with the techniques of this disclosure.

FIG. 2 is a block diagram illustrating an example system that may perform the techniques of this disclosure.

FIG. 3 is a block diagram illustrating implementation of a pre-processing framework of a vehicle assistance system before driving, in accordance with the techniques of this disclosure.

FIG. 4 is a block diagram illustrating implementation of a framework of the vehicle assistance system during driving, in accordance with the techniques of this disclosure.

FIG. 5 illustrates transformations from panoramic to Perspective View (PV) pictures, in accordance with the techniques of this disclosure.

FIG. 6 is a flowchart illustrating an example method for enhancing perception range of a computer vision system, in accordance with the techniques of this disclosure.

### DETAILED DESCRIPTION

Surround view cameras, while providing a comprehensive view of the surroundings of a vehicle, face certain limitations, primarily stemming from their single-viewpoint nature and limited stereo overlap. Each surround view camera may capture the scene from a fixed point, providing a 2D picture. However, this single viewpoint inherently limits the ability of a vehicle assistance system, such as an ADAS (Advanced Driver Assistance System), to accurately perceive depth information. Without stereo vision, the vehicle assistance system may encounter difficulties in determining the precise distance of objects, especially the objects located at the edges of the field of view of a particular surround view camera. Objects at different distances may appear similar in size in the 2D picture, challenging the vehicle assistance system to distinguish between such objects. Depth ambiguity may lead to misinterpretations, especially in low-light conditions or when dealing with complex scenes. Furthermore, as objects move farther from the surround view camera, these objects may occupy fewer pixels in the picture. This reduction in pixel density may lead to a loss of fine details and may provide difficulties for deep learning models to accurately identify and classify objects which are farther away from the camera. Distant objects are more likely to be occluded by nearer objects, further hindering accurate perception.

An Advanced Driver Assistance System (ADAS) is one type of vehicle assistance system. The ADAS is a collection of technologies or systems that may be integrated into a vehicle to enhance safety and improve driving experiences. These systems may use sensors, cameras, radar, LiDAR, and software to monitor the surroundings of a vehicle, analyze driving conditions, and either warn the driver of potential hazards or take partial or full control of the vehicle to prevent accidents. Examples of ADAS technologies may include, but are not limited to: Adaptive Cruise Control (ACC), Lane Departure Warning (LDW) and Lane Keeping Assist (LKA), Automatic Emergency Braking (AEB), blind spot detection, traffic sign recognition, parking assistance, and driving monitoring systems. The ACC may be configured to automatically adjust the vehicle's speed to maintain a safe distance from the vehicle ahead. The LDW and LKA may be configured to alert the driver when the vehicle unintentionally drifts out of its lane or actively steers the vehicle back into the lane. The AEB may be configured to detect potential collisions and to apply brakes to avoid or reduce the impact. The blind spot detection system may be configured to warn drivers of vehicles or objects in their blind spots. The traffic sign recognition system may be configured to identify and display traffic signs, such as speed limits or stop signs, to the driver. The parking assistance system may use sensors and cameras to assist with parking, sometimes automating the process. The driver monitoring system may be configured to detect driver fatigue or distraction and may issue alerts or may take corrective actions.

Some example computer vision systems may utilize map-aware Bird's Eye View (BEV) modeling techniques to improve perception capabilities and extend the effective perception range. In other words, the map-aware BEV modeling techniques combine the power of camera-based perception with high-definition maps to provide a more comprehensive understanding of the driving environment.

BEV maps augment camera images with BEV information to improve depth estimation and 3D object segmentation. For example, by combining camera images with map data, the traditional models may more accurately estimate the depth of objects, especially at longer distances.

The minimal overlap between the surround view cameras may limit the opportunities for stereo matching, which is a technique used to calculate depth information. In the context of autonomous driving and computer vision, without sufficient overlap, the vehicle assistance system may struggle to accurately estimate the depth of objects, particularly the objects located at the boundaries of the field of view of the surround view cameras. To mitigate the aforementioned limitations, various techniques may be employed by the disclosed system. Combining surround view cameras with other sensors, such as, but not limited to, LiDAR or radar, may provide more accurate depth information and may improve overall perception capabilities. Algorithms may be used to analyze the 2D images and infer depth information, although this approach may be computationally intensive. By carefully calibrating the surround view cameras and using techniques like epipolar geometry, more depth information may be extracted from the pictures. Furthermore, as objects move farther from the surround view camera, these objects may occupy fewer pixels in the picture. This reduction in pixel density may lead to a loss of fine details and may provide difficulties for deep learning models to accurately identify and classify objects. Distant objects are more likely to be occluded by nearer objects, further hindering accurate perception. Weather factors, such as, but not limited to fog, rain, or haze may degrade picture quality and may reduce visibility, especially at longer distances. To mitigate the aforementioned limitations, especially when the driving path is known in advance, the disclosed technique may employ pre-processing.

For example, a vehicle assistance system may perform map data analysis. The vehicle assistance system may identify static objects, such as, but not limited to, buildings, trees, and traffic signs from high-resolution maps or satellite imagery. The vehicle assistance system may extract locations of lane markings, road boundaries, and other relevant road features. Some scenarios may highlight potential hazards like construction zones, accidents, or road closures.

During pre-processing, the vehicle assistance system may extract relevant features from the pre-processed map data, such as, but not limited to, lane curvature, road width, and object locations. The vehicle assistance system may create depth maps to estimate the distance to objects in the scene. During real-time perception, the vehicle assistance system may utilize the pre-processed information to track objects over time, improving their detection and classification accuracy. The vehicle assistance system may combine real-time camera input with pre-processed data to form a more comprehensive understanding of the driving environment.

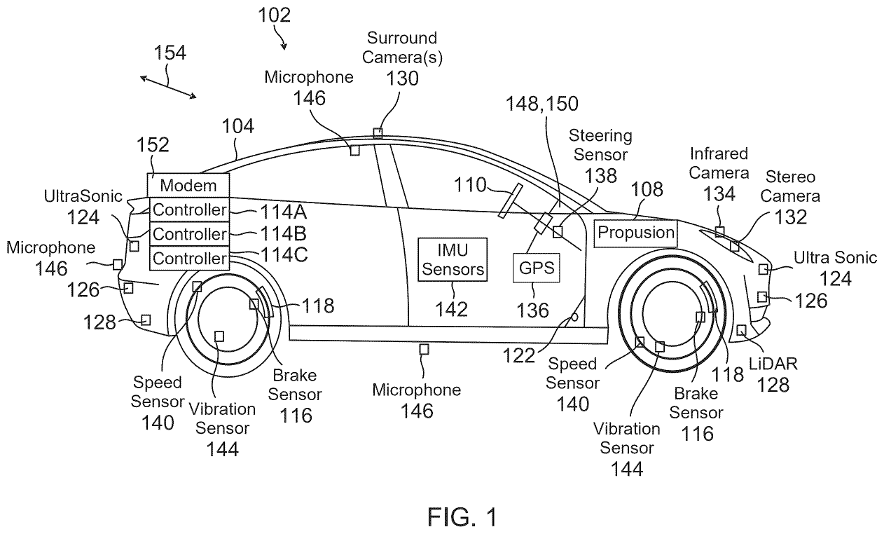

FIG. 1 shows an example vehicle 102. Vehicle 102 in the example shown may comprise a passenger vehicle such as a car or truck that can accommodate a human driver and/or human passengers. In an aspect, vehicle 102 may comprise an autonomous vehicle, semi-autonomous vehicle and/or vehicle with an ADAS system. Vehicle 102 may include a vehicle body 104 suspended on a chassis, in this example comprised of four wheels and associated axles. A propulsion system 108 such as an internal combustion engine, hybrid electric power plant, or even all-electric engine may be connected to drive some or all of the wheels via a drive train, which may include a transmission (not shown). A steering wheel 110 may be used to steer some or all of the wheels to direct vehicle 102 along a desired path when the propulsion system 108 is operating and engaged to propel the vehicle 102. Steering wheel 110 or the like may be optional for Level 5 implementations. One or more controllers 114A-114C (a controller 114) may provide autonomous capabilities in response to signals continuously provided in real-time from an array of sensors, as described more fully below.

Each controller 114 may be essentially one or more onboard computers that may be configured to perform deep learning and/or artificial intelligence functionality and output autonomous operation commands to self-drive vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide artificial intelligence functionality for in-camera sensors, and controller 114D (not shown) may provide infotainment functionality and provide additional redundancy for emergency situations.

Controller 114 may send command signals to operate vehicle brakes 116 via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”)—a network inside modern cars used to control brakes, acceleration, steering, windshield wipers, and the like. The CAN bus may be configured to have dozens of nodes, each with its own unique identifier (CAN ID). The bus may be read to find steering wheel angle, ground speed, engine RPM, button positions, and other vehicle status indicators. The functional safety level for a CAN bus interface is typically Automotive Safety Integrity Level (ASIL) B. Other protocols may be used for communicating within a vehicle, including FlexRay and Ethernet.

In an aspect, an actuation controller may be obtained with dedicated hardware and software, allowing control of throttle, brake, steering, and shifting. The hardware may provide a bridge between the vehicle's CAN bus and the controller 114, forwarding vehicle data to controller 114 including the turn signal, wheel speed, acceleration, pitch, roll, yaw, GPS data, tire pressure, fuel level, sonar, brake torque, and others. Similar actuation controllers may be configured for any other make and type of vehicle, including special-purpose patrol and security cars, robo-taxis, long-haul trucks including tractor-trailer configurations, tiller trucks, agricultural vehicles, industrial vehicles, and buses.

Controller 114 may provide autonomous driving outputs in response to an array of sensor inputs including, for example: one or more ultrasonic sensors 124, one or more RADAR sensors 126, one or more LiDAR sensors 128, one or more surround view cameras 130 (typically such cameras are located at various places on vehicle body 104 to image areas all around the vehicle body), one or more stereo cameras 132 (in an aspect, at least one such stereo camera may face forward to provide object recognition in the vehicle path), one or more infrared cameras 134, GPS unit 136 that provides location coordinates, a steering sensor 138 that detects the steering angle, speed sensors 140 (one for each of the wheels), an inertial sensor or inertial measurement unit (“IMU”) 142 that monitors movement of vehicle body 104 (this sensor can be for example an accelerometer(s) and/or a gyro-sensor(s) and/or a magnetic compass(es)), tire vibration sensors 144, and microphones 146 placed around and inside the vehicle. Other sensors may be used, as is known to persons of ordinary skill in the art.

Controller 114 may also receive inputs from an instrument cluster 148 and may provide human-perceptible outputs to a human operator via human-machine interface (“HMI”) display(s) 150, an audible annunciator, a loudspeaker and/or other means. In addition to traditional information such as velocity, time, and other well-known information, HMI display 150 may provide the vehicle occupants with information regarding maps and vehicle's location, the location of other vehicles (including an occupancy grid) and even the Controller's identification of objects and status. For example, HMI display 150 may alert the passenger when the controller has identified the presence of a stop sign, caution sign, or changing traffic light and is taking appropriate action, giving the vehicle occupants peace of mind that the controller 114 is functioning as intended.

In an aspect, instrument cluster 148 may include a separate controller/processor configured to perform deep learning and artificial intelligence functionality.

Vehicle 102 may collect data that is preferably used to help train and refine the neural networks used for autonomous driving. The vehicle 102 may include modem 152, preferably a system-on-a-chip that provides modulation and demodulation functionality and allows the controller 114 to communicate over the wireless network 154. Modem 152 may include an RF front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: LTE, WCDMA, UMTS, GSM, CDMA2000, or other known and widely used wireless protocols.

Compared to sonar and RADAR sensors 126, cameras 130-134 may generate a richer set of features at a fraction of the cost. Thus, vehicle 102 may include a plurality of cameras 130-134, capturing images around the periphery of the vehicle 102. Camera type and lens selection depends on the nature and type of function. The vehicle 102 may have a mix of camera types and lenses to provide complete coverage around the vehicle 102. All camera locations on the vehicle 102 may support interfaces such as Gigabit Multimedia Serial link (GMSL) and Gigabit Ethernet.

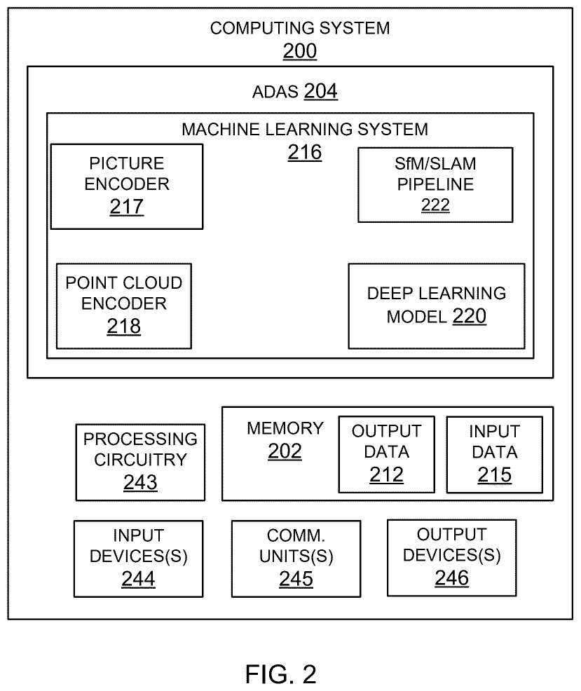

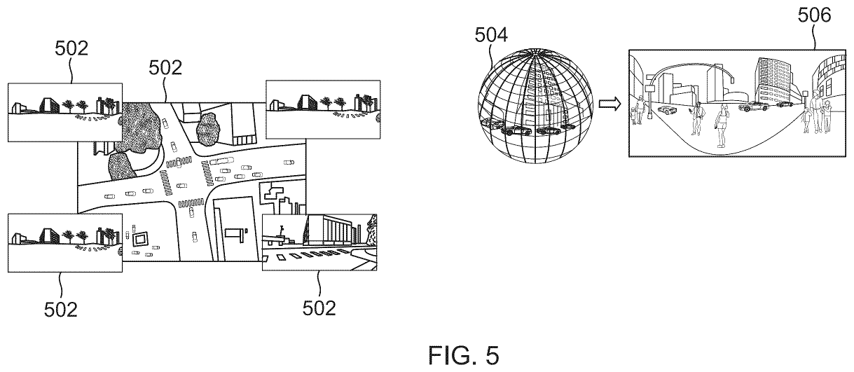

In an aspect, a controller 114 may be configured to obtain a plurality of panoramic pictures related to an intended driving trajectory of the vehicle 102. 102. For example, the street-level panoramas (e.g. panoramic pictures 502 shown in FIG. 5) may provide a comprehensive view of the environment surrounding vehicle 102, including, but not limited to, roads, buildings, and other objects. Next, controller 114 may convert each of the plurality of panoramic pictures into a plurality of perspective pictures. Controller 114 may then apply one or more machine learning models to the plurality of perspective pictures to generate information related to a plurality of static road objects. In an aspect, controller 114 may employ one or more deep learning models 220 shown in FIG. 2 trained on large datasets of pictures to extract aforementioned information. Next, controller 114 may generate a 3D point cloud corresponding to the intended travel trajectory of the vehicle 102 by performing a 3D reconstruction on the plurality of perspective pictures.

In accordance with the techniques of the present disclosure, Structure-from-Motion (SfM) SfM or MultiViewStereo (MVS) techniques may be applied to the plurality of perspective pictures to generate a 3D point cloud. Controller 114 employing the SfM/MVS techniques may match corresponding features across different perspective pictures 306 to establish correspondences. In an aspect, controller 114 may also extract, using the 3D point cloud, locations of the plurality of static road objects. The static road may include objects such as, but not limited to, traffic signs, traffic lights, and lane markings. Finally, controller 114 may operate a vehicle assistance system, while the vehicle is moving along the intended driving trajectory, based on the information related to the plurality of static road objects and the locations of the plurality of static road objects.

FIG. 2 is a block diagram illustrating an example computing system 200. As shown, computing system 200 comprises processing circuitry 243 and memory 202 for executing Machine Learning (ML) system 216 of ADAS 204, including picture encoder 217, point cloud encoder 218, and one or more deep learning models 220 which may represent an example instance of any controller 114 described in this disclosure, such as controller 114 of FIG. 1. ADAS 204 may comprise an autonomous driving system and/or any other vehicle assistance system. ML system 216 may comprise various types of neural networks, such as, but not limited to, recursive neural networks (RNNs), convolutional neural networks (CNNs), deep neural networks (DNNs), and transformers. For example, ML system 216 may also include an object detection model not shown in FIG. 2.

Computing system 200 may also be implemented as any suitable external computing system accessible by controller 114, such as one or more server computers, workstations, laptops, mainframes, cloud computing systems, High-Performance Computing (HPC) systems (i.e., supercomputing) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 200 comprises any suitable computing system having one or more computing devices, such as desktop computers, laptop computers, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network—PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more aspects of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules or units described in accordance with one or more aspects of this disclosure.

Processing circuitry 243 and memory 202 may provide an operating environment or platform for one or more modules or units (e.g., picture encoder 217, point cloud encoder 218, and deep learning model 220), which may be implemented as software, but may in some examples include any combination of hardware, firmware, and software. Processing circuitry 243 may execute instructions and the one or more storage devices, e.g., memory 202, may store instructions and/or data of one or more modules or units. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute ADAS 204 using virtualization modules, such as a virtual machine or container executing on underlying hardware. One or more of such modules may execute as one or more services of an operating system or computing platform. Aspects of ADAS 204 may execute as one or more executable programs at an application layer of a computing platform.

One or more input devices 244 of computing system 200 may generate, receive, or process input. Such input may include input from a video camera, sensor, keyboard, pointing device, voice responsive system, biometric detection/response system, button, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

In the example of FIG. 2, picture encoder 217 may be configured to extract features from input data 215, as described herein. Picture encoder 217 may receive input from sensors such as, but not limited to, cameras 130-134. Point cloud encoder 218 may also be configured to extract features from input data 215, as described herein. Point cloud encoder 218 may receive input from sensors such as, but not limited to, LiDAR sensors 128. Picture encoder 217 and point cloud encoder 218 may generate output data 212. Input data 215 and output data 212 may contain various types of information. For example, input data 215 may include, but is not limited to, camera image data, LiDAR point cloud data, GPS/GNSS coordinates, and so on. Output data 212 may include a BEV feature map that represents the scene in a top-down view, semantic labels, and the like.

Some example computer vision systems use the integration of map information to disambiguate objects and to improve accuracy of segmentation. The models in such systems may perceive objects beyond the immediate camera view by leveraging the map data. Computer vision systems employing generative pre-trained models, such as BEVGPT, leverage historical BEV pictures and driving decisions to generate future BEV predictions. By predicting future states of the environment, the pre-trained generative models may anticipate potential hazards and may react proactively. For example, the BEVGPT model may generate driving trajectories by considering future predictions. The integration of dynamic object prediction and high-definition maps provides a better understanding of the driving scenario. As another example of conventional systems, a WidthFormer model utilizes advanced positional encoding and transformer modules to transform multi-view picture features into BEV features. The WidthFormer model processes multi-view pictures and generates BEV features. The architecture of the WidthFormer model may reduce the computational cost of BEV perception. The refined BEV features may provide a more detailed representation of the driving environment.

While the aforementioned conventional techniques that integrate map information to disambiguate object detections offer advancements in computer vision perception, these techniques are not without limitations. One limitation is the reliance of the aforementioned techniques on localized information, which may hinder long-range perception accuracy. These techniques heavily rely on real-time sensor data, such as camera pictures and LiDAR point clouds.

Any limitations or inaccuracies in the sensor inputs may directly impact the performance of the computer vision system. In adverse weather conditions or challenging lighting scenarios, the performance of the computer vision system may degrade significantly. While conventional approaches can extend the perception range to some extent, these approaches still primarily rely on localized information captured by the sensors of the vehicle. This can limit the ability to accurately perceive distant objects or anticipate potential hazards far ahead. For example, in scenarios with limited visibility, such as fog or heavy rain, the conventional autonomous driving system may struggle to detect objects at a distance.

The conventional approaches described above require significant computational resources, especially when dealing with high-resolution sensor data and complex deep learning models. These computational requirements can be a challenge for real-time implementation, particularly on edge devices with limited processing power.

The accuracy of the map data used in conventional approaches is important. As noted above, inaccurate or outdated maps may lead to erroneous perception and decision-making. Map data is preferably continuously updated to reflect changes in the environment, such as road construction or new traffic signs. To mitigate these limitations, ADAS 204 disclosed herein may employ techniques like, but not limited to, combining data from different sensors, such as LiDAR sensors 128 and cameras 130-134, to improve the accuracy and robustness of perception. In an aspect, the ML system 216 may utilize accurate and detailed maps, which may provide valuable contextual information, especially for long-range perception. Using contextual information, the ML system 216 may employ more advanced deep learning models to improve the accuracy and efficiency of perception tasks.

The ML system 216 addresses the limitations of relying solely on real-time sensor data by employing the disclosed techniques to pre-process static environmental information before the journey of the vehicle 102. Generally, in the context of vehicles having a vehicle assistance system, the ML system 216 may use the precise location of the vehicle 102 to query a mapping API database. In one example, ML system 216 may fetch panoramic pictures of the entire trajectory, providing a 360-degree view of the route. Advantageously, by pre-processing static information, the ML system 216 may focus computational resources on dynamic elements like moving vehicles and pedestrians. Pre-processed data may provide more precise information about static objects, aiding in tasks like lane detection, obstacle avoidance, and traffic light recognition, as described in greater detail below.

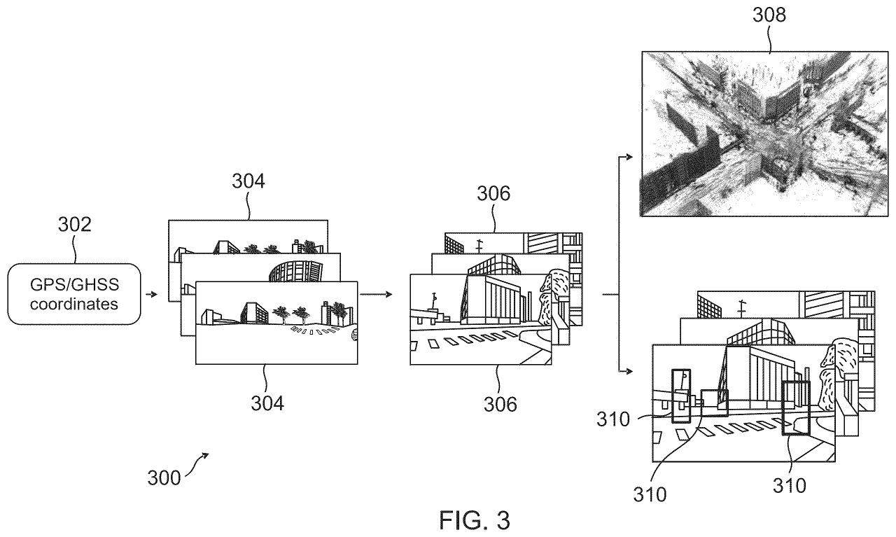

Pre-processed data (shown in FIG. 3) may allow the ML system 216 to respond faster to real-time changes in the environment. In the context of 3D object detection, pre-processed panoramas (also referred to herein as “panoramic pictures”) may provide a more detailed understanding of the static environment, extending the perception range beyond the immediate sensor view. In an aspect, by leveraging pre-processed information, the ML system 216 may become less reliant on real-time sensor data, improving robustness in adverse weather conditions, for example. While data obtained from a mapping API (e.g., Google Street view data) may not always be up to date, such data may provide a valuable baseline for analyzing the static environment around the vehicle 102.

In one aspect of the disclosure., the panoramic picture may be transformed into multiple overlapping perspective pictures. As explained earlier, each perspective picture may be projected to simulate the view from one or more cameras 130-134 of the vehicle 102 at specific points along the route. The ML system may apply one or more lightweight picture-only deep learning model(s) 220 to each perspective picture. In one aspect, the lightweight picture-only deep learning model(s) 220 may be specialized neural networks designed to be efficient in processing and analyzing images. These deep-learning models are called “lightweight” because they may be configured to be smaller and faster, making these models suitable for resource-constrained devices or real-time applications. The disclosed combined techniques may utilize the deep learning models 220 to generate priors (shown in FIG. 3) for static road objects such as, but not limited to, traffic signs, traffic lights, and lane markings.

Typically, lightweight models are suitable for real-time processing on embedded systems. These deep learning models 220 may provide accurate predictions for static objects, especially when trained on large datasets. The ML system 216 may use the perspective pictures to reconstruct a 3D model of the scene. If appropriate, the ML system 216 may employ computer vision 3D reconstruction techniques, such as but not limited to deep learning-based techniques for 3D reconstruction. As an example, COLMAP is a general-purpose Structure-from-Motion (SfM) and Multi-View Stereo (MVS) pipeline with a graphical and command-line interface. 3D reconstruction techniques may offer a wide range of features for reconstruction of ordered and unordered image collections. For example, 3D reconstruction may provide accurate depth information for objects in the scene. The exemplary deep learning based techniques may use deep learning model(s) 220 (e.g., DNNs) to extract dense feature maps and match them across pictures. In an aspect. the ML system 216 may train deep learning models 220 on large datasets of pictures to learn robust feature representations. In an aspect, the ML system 216 may directly predict 3D point clouds or mesh models from input pictures.

In an example, 3D reconstruction using 3D point cloud or mesh generated by the SfM/SLAM (Simultaneous Localization And Mapping) pipeline 222 may enable a better understanding of the geometry of the scene and object locations, aiding the ADAS 204 in tasks like obstacle avoidance and navigation of the vehicle 102. By combining pre-processed information with real-time sensor data, the ML system 216 may achieve a more accurate and robust understanding of the environment.

The pre-processed 3D models generated by the ML system 216 may provide valuable information about the environment at a distance, extending the perception range. The use of lightweight deep learning models 220 and efficient 3D reconstruction techniques (shown in FIG. 3) may reduce the computational burden on the ML system 216.

As described below, the reconstructed 3D point cloud may be analyzed to identify and extract the 3D locations of static road objects like traffic signs, traffic lights, and lane markings. Various features, such as, but not limited to, shape, color, and texture, may be extracted from these 3D points. In certain operations, like obstacle avoidance and path planning, the extracted features and 3D locations may be used to generate priors for these static road objects.

In some cases, the reconstructed 3D scene may be aligned with the real-time sensor data, such as, but not limited to camera pictures and point clouds generated based on data provided by LiDAR sensors 128. Advantageously, the ML system 216 may determine precise location and orientation of the vehicle 102 within the reconstructed 3D scene.

As noted above, more precise localization may better ensure that the ML system 216 correctly interprets the sensor data, improving the precision of object detections. Accurate detection of objects around the vehicle 102 may allow for consistent mapping of virtual objects onto the real-world scene.

In an aspect, while vehicle 102 is in motion, a specific area of interest may be cropped from the 3D scene, typically a region ahead of the vehicle 102. For example, the ML system 216 may crop 150 m radius ahead of the vehicle 102. This range may allow for sufficient look-ahead distance to anticipate potential hazards. In addition, the ML system 216 may crop, for example, 50 m lateral range. This lateral range may cover the area around the vehicle 102, enabling safe lane changes and obstacle avoidance.

In other words, by focusing on the relevant area, the computational cost of perception tasks may be reduced. The ML system 216 may prioritize processing of critical regions, which may enhance real-time performance. The pre-processed priors may be used to guide the detection of static objects in real-time sensor data, improving accuracy and reducing false positives. As noted above, the 3D locations and features of static objects may be used to track the static objects over time and predict future positions of these objects.

To improve the accuracy and robustness of lane detection, traffic sign detection, and traffic light detection, the disclosed techniques may include querying relevant pictures (shown in FIG. 3) within a specific range of the vehicle 102. Pictures containing detections of at least one target road objects may be identified. Pictures within a 150 m radius of the vehicle 120 may be selected to better ensure a sufficient look-ahead distance.

In an example, the ML system 216 may employ a deep learning vectorized high-definition (HD) map construction framework for lane detection. As a non-limiting example, MapTRV2 is a lane detection model that leverages a transformer-based architecture. The HD map framework may be capable of handling complex lane scenarios, including, but not limited to, curved roads, intersections, and challenging lighting conditions. As described in greater detail below, a 2D backbone network (like ResNet or EfficientNet) may extract features from input data 215. The extracted features may be fed into the HD map framework to capture long-range dependencies between different parts of the picture. The HD map framework may generate lane instance segmentation masks, predicting the location and shape of each lane. The predicted lane masks may be refined using techniques like non-maximum suppression to obtain accurate lane boundaries. Advantageously, the HD map framework may handle diverse driving scenarios, including, but not limited to challenging weather conditions and low-light situations. The HD map framework may detect lane boundaries, even in complex scenarios.

In an aspect, the ML system 216 may employ an object detection model to detect objects in each picture, including, but not limited to, traffic signs. Furthermore, the ML system 216 may utilize the M3E (Multi-Modal Mutual Enhancement) module (not shown in FIG. 2) to extract high-level semantic information from the detected objects, such as traffic sign type and text. In an aspect, the ML system 216 may leverage the 3D scene understanding to improve the accuracy of object detection and recognition. For example, the ML system 216 may consider the relative positions of objects and the spatial relationships between the objects.

A deep neural network of an object detection model, such as, but not limited to, YOLOv8 model, may extract features from the input data 215. The feature maps may be fed into a prediction head, which may predict bounding boxes and class probabilities for objects in the corresponding picture, including, but not limited to, traffic lights. The object detection model may apply non-maximum suppression to filter out redundant detections and refine the final predictions. The object detection model may detect a wide range of objects, including, but not limited to, traffic lights, vehicles, and pedestrians in various lighting conditions and challenging environments.

By combining the object detection model with the techniques disclosed herein, the vehicle assistance system may use this information to assist the driver in staying within the lane and avoiding lane departures. The vehicle assistance system may automatically detect traffic lights and trigger appropriate actions, such as braking or accelerating. By integrating lane detection and traffic light detection with data provided by other sensors (e.g., LiDAR sensors 128), the vehicle assistance system may make informed decisions about vehicle control and path planning.

In accordance with the techniques of the present disclosure, by focusing on relevant pictures, the computational cost of detection tasks of the vehicle assistance system may be reduced. Analyzing multiple pictures may enhance the reliability of detection and tracking. Multimodal learning in BEV space may leverage multiple sensory inputs to improve the overall perception performance. By combining information from different modalities, a more comprehensive and accurate understanding of the driving environment may be achieved. Camera pictures in the disclosed techniques may provide detailed visual information about the scene, including, but not limited to, texture, color, and shape, allowing for more accurate and robust object detection in 3D environments.

In the example of the framework illustrated in FIG. 3, perspective pictures may enable real-time perception of dynamic objects and environmental changes during journey of the vehicle 102. The reconstructed 3D point cloud may provide precise depth information, aiding in accurate object localization and distance estimation, potentially improving object detection. For example, 3D static road object localization may associate the detected static objects with specific 3D regions in the scene.

The reconstructed 3D point cloud may capture the static environment, including, but not limited to, road geometry, lane markings, and static obstacles. In an aspect, relevant pictures with detections may provide specific information about the location and appearance of objects of interest. In an aspect, the ML system 216 may project the 2D bounding boxes from the picture-based detector onto the 3D scene using the camera poses and projection matrices. In simpler terms, by analyzing the relevant pictures, the ML system 216 may gain a better understanding of the context and scene dynamics. Features may be extracted from each modality, such as, but not limited to, visual features from camera pictures and geometric features from the reconstructed point cloud. As noted above, the extracted features may be fused in BEV space, allowing for a unified representation of the environment surrounding vehicle 102.

FIG. 3 is a block diagram illustrating implementation of a pre-processing framework 300 of a vehicle assistance system before driving, in accordance with the techniques of this disclosure. As shown in FIG. 3, the ML system 216 may receive input data in the form of GPS/GNSS coordinates 302 of the vehicle 102. As noted above, ML system 216 may retrieve a plurality of panoramic pictures 304, based on the received GPS/GNSS coordinates 302, using a mapping API. As a non-limiting example, Google Street view is a Google Maps feature that allows users to virtually explore streets and locations worldwide. By inputting the GPS/GNSS coordinates of a particular location into Google Maps or a compatible mapping API application, ML system 216 may access the closest available street view panoramic pictures 304 for that location.

In the context of the pre-processing framework 300, a street view panorama (e.g., panoramic pictures 304) may be a 360-degree picture capturing the entire scene around a particular point. The ML system 216 may extract one or more perspective pictures 306 from the panoramic pictures 304. Perspective picture 306 may be a 2D picture with a specific field of view, simulating what a camera would capture from a particular viewpoint within the panorama. Various techniques may be employed by the ML system 216 to extract perspective pictures 306 from panoramic pictures 304. In this case, the ML system 216 may select a specific portion of the panoramic pictures 304.

In an aspect, the ML system 216 may project the spherical panorama onto a planar surface, as described below in conjunction with FIG. 5.

To accomplish the process illustrated in FIG. 3, the ML system 216 may employ one of the following techniques.

In one example, a mapping API, such as Google Maps API may allow programmatic access to Google Maps data, including, but not limited to, street view imagery. Similarly, OpenStreetMap is an open-source mapping API that may provide access to street-level imagery and APIs for querying and processing data.

Advantageously, libraries like OpenCV and Pillow may be used by ML system 216 to manipulate and extract perspective pictures 306 from panoramic pictures 304.

Algorithms like feature matching and homography estimation may be used by ML system 216 to accurately align and warp pictures shown in FIG. 3.

Accordingly, ML system 216 may employ the multi-step process illustrated in FIG. 3 to extract meaningful information from visual data. In an aspect, as noted above, panoramic pictures 304 may be 360-degree pictures capturing the entire scene around a particular point. The ML system 216 may extract 2D pictures (e.g., perspective pictures 306) from the panoramic pictures 304, simulating a specific camera view.

In the example illustrated in FIG. 3, 3D point cloud 308 may be a set of 3D points representing the geometry of the scene. In an aspect, the ML system 216 may employ SfM or SLAM techniques to reconstruct 3D scenes from multiple 2D pictures.

As a non-limiting example, the ML system 216 employing SfM/SLAM pipeline 222 may first identify distinctive features (e.g., information about physical objects) in the perspective pictures 306. Next, the ML system 216 may match corresponding features across different perspective pictures 306 to establish correspondences. The ML system 216 may determine the camera position and orientation for each perspective pictures 306. The ML system 216 may use geometric constraints (e.g., epipolar geometry) to estimate the relative camera poses between pairs of perspective pictures 306. The ML system 216 may employ optimization techniques like bundle adjustment to refine the camera poses and minimize reprojection errors. Finally, the ML system 216 may generate 3D point cloud 308 by triangulating 3D points from the matched features. Alternatively, the ML system 216 may generate the 3D point cloud 308 based on LiDAR data provided by one or more LiDAR sensors 128.

ML system 216 may obtain reliable information about physical objects and the environment through the process of recording, measuring, and interpreting photographic pictures, for example. The resulting apriori detections, referred to herein as pre-processed priors 310, may include identifying and locating objects within the scene. With the disclosed techniques, the ML system 216 may use one or more trained models to classify objects based on features of the objects in perspective pictures 306. These models may be specifically trained to identify and locate static road objects within these images (e.g., traffic signs, lane markings, road barriers). The output of the process illustrated in FIG. 3 may be assigned one or more semantic labels (e.g., car, pedestrian, building) to each point in the point cloud 308 and/or the perspective pictures 306. In an aspect, the ML system 216 may better understand the 3D environment analyzed by the framework 300 for safe navigation during driving.

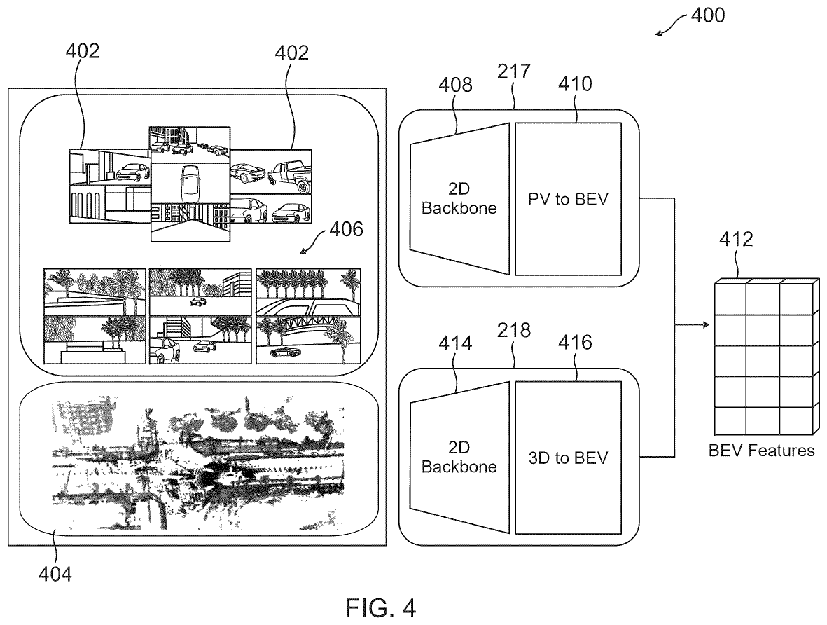

FIG. 4 is a block diagram illustrating implementation of framework 400 of the vehicle assistance system during driving, in accordance with the techniques of this disclosure. Surround View (SV) camera systems are common in modern vehicles. In an aspect, a vehicle assistance system may employ an SV camera system may consist of four fisheye SV cameras 130 mounted on the corners of the vehicle 102, providing a 360-degree view of the surroundings. Accurate localization of the SV cameras 130 may be important for various applications, including, but not limited to, autonomous driving, vehicle assistance system, and parking assistance.

Intrinsic calibration determines the internal parameters of the SV camera 130, such as, but not limited to focal length, principal point, and distortion coefficients. In an aspect, extrinsic calibration may determine the relative positions and orientations of the SV cameras 130 with respect to each other and the coordinate system of the vehicle 102.

The point cloud 308 generated during-pre-processing stage shown in FIG. 3 may need some post-processing to improve quality and suitability of the point cloud 308 for specific applications. For example, the ML system 216 may align the post-processed point cloud 404 (referred to hereinafter as simply point cloud 404) with the center of gravity of the vehicle 102 or a specific reference point. The point cloud 404 may be cropped to focus on the area of interest, such as the immediate surroundings of the vehicle 102. The ML system 216 may remove outliers and noise in the point cloud 404 to improve the quality of the 3D representation.

In an aspect, the ML system 216 may select one or more relevant pictures 406 from pre-processed priors 310. The relevant pictures 406 reduce computational load and storage requirements by representing significant changes in the scene. Here, relevant pictures 406 may provide a clear view of obstacles and tight parking spaces, for example. The ML system 216 may help drivers detect vehicles in blind spots. The disclosed techniques may also help the ML system 216 to perform early detection of potential hazards.

As shown in FIG. 4, SV pictures 402 and relevant pictures 406 may be fed as input to a first encoder, the picture encoder 217. The specific SV pictures 402 may be a collection of pictures captured by SV cameras 130 placed around the vehicle 102 (e.g., front, back, and sides of the vehicle 102). The SV pictures 402 may provide a comprehensive view of the surroundings of the vehicle 102. As a non-limiting example scenario, relevant pictures 406 may be selected by the ML system 216 from the stream of the pre-processed priors 310 based on certain criteria, such as presence of objects of interest in the scene. Next, the ML system 216 may process the selected relevant pictures 406 and SV pictures 402, which may include resizing, normalization, and other picture transformations. The relevant pictures 406 may be used to reduce computational costs and focus on the relevant information.

In an aspect, the picture encoder 217 may include a 2D backbone network 408, which may process the SV pictures 402 and the relevant pictures 406. The 2D backbone network 408 may comprise a 2D image-based backbone, such as, but no limited to, ResNet, Vision Transformers or EfficientNet.

The picture encoder 217 may be configured to perform Perspective View (PV) to Bird's-Eye View (BEV) transformation 410. The picture encoder 217 may use intrinsic and extrinsic parameters of each SV pictures 402 as well as crowd-source pre-processed priors 310 to project to BEV space.

The 2D features extracted by the 2D backbone network 408 of the picture encoder 217 may be projected onto the BEV space, creating a bird's-eye view representation of the scene using techniques such as but not limited to, Lift Splat Shoot. As shown in FIG. 3, the ML system 216 may aggregate the projected features from different SV cameras 130 as well as crowd-source pre-processed priors 310 in the BEV space. The aggregation may be performed using techniques such as, but not limited to, feature pooling or attention mechanisms. The final output of the PV to BEV transformation 410 may be BEV feature map 412 that represents the captured scene in a top-down view. This BEV feature map 412 may be used by a vehicle assistance system for various tasks, such as, but not limited to, object detection, semantic segmentation, and motion prediction.

The BEV feature map 412 may provide a unified representation of the scene, better representing spatial relationships between detected objects. The BEV features may improve the performance of various autonomous driving tasks, such as object detection and motion prediction.

Generally, in the context of autonomous driving, point clouds, obtained from LiDAR sensors 128, provide a 3D representation of the environment. Processing the point cloud to extract meaningful features may be important for tasks like object detection, semantic segmentation, and motion prediction.

As shown in FIG. 4, the point cloud 404 may be used as input to a second encoder, namely, the point cloud encoder 218. This input point could 404 may be obtained by either using point cloud 308 generated during preprocessing stage and/or may be obtained from LiDAR sensors 128.

As shown in FIG. 4, a raw point cloud 404 may comprise a set of points, each with (x, y, z) coordinates, representing the 3D location of objects in the scene. The ML system 216 may process the raw point cloud 404, which may include processing steps such as, but not limited to, noise filtering, ground segmentation and normalization. In an aspect, noise filtering may include removing outliers and noise points.

As additional examples of point cloud processing, ground segmentation may include identifying and removing ground points. Normalization may include scaling and shifting point coordinates to a common range.

The point cloud encoder 218 may include 3D backbone network 414. The processed point cloud 404 may be fed into the 3D backbone network 414 of the point cloud encoder 218, which may learn to extract features from the 3D point cloud 404 data.

The 3D backbone network 414 may be based on various architectures, such as, but not limited to, PointNet, PointNet++, or voxel-based architectures. The 3D backbone network 414 may learn to capture spatial and semantic information from the point cloud 404. As shown in FIG. 4, the point cloud encoder 218 may be configured to perform 3D to BEV transformation 416.

The point cloud encoder 218 may project 3D point cloud features onto a 2D BEV plane. In an aspect, this projection (BEV transformation 416) may include mapping 3D points to their corresponding 2D coordinates in the BEV space.

The projected features from different 3D points may be aggregated into the dense BEV feature map 412. Such aggregation may be achieved using techniques such as, but not limited to, voxel-based feature aggregation or attention mechanisms.

The point cloud encoder 218 may output the BEV feature map 412 that represents the scene in a top-down view. This BEV feature map 412 may contain rich information about the scene, including, but not limited to, object locations, shapes, and semantic labels.

As noted above, the BEV features may provide a unified representation of the captured scene, better representing spatial relationships between objects. In an aspect, the BEV features may improve the performance of various autonomous driving tasks of a vehicle assistance system, such as, but not limited to, object detection and motion prediction.

Cameras 130-134 primarily capture 2D pictures, making it difficult to accurately perceive depth, especially in challenging lighting conditions or at longer distances. In camera only systems objects may be occluded by other objects, leading to missed detections or inaccurate localization. Adverse weather conditions such as, but not limited to, rain, fog, or snow may significantly degrade camera performance. Point cloud 308 generated from crowd-source pictures during-pre-processing stage shown in FIG. 3 may enhance object detection and localization, especially in challenging scenarios. LiDAR sensors 128 may also be used as an additional modality with the pointcloud 308 to further improve the performance.

As noted above, the ML system 216 may identify relevant pictures 406 from multiple viewpoints within a 150-meter range. The ML system 216 may use techniques, such as, but not limited to, SfM and MVS to reconstruct the 3D point cloud 404 from the selected relevant pictures 406. Filtering, denoising, and feature extraction may be applied to the reconstructed point cloud 404 by the ML system 216.

The disclosed ML system 216 may fuse the 3D point cloud 404 with the SV pictures 402 to create a richer, more informative representation of the scene. Accurate depth information may improve object detection and localization, especially at longer distances.

In other words, ML system 216 may employ one or more ML models trained on a dataset of crowd-sourced pictures. These models may be specifically trained to identify and locate static road objects within these pictures (e.g., traffic signs, lane markings, road barriers). As noted above, the ML system 216 may identify relevant pictures 406. Advantageously, ML system 216 may selectively choose only those pictures where the aforementioned ML models successfully detected at least one static road object. This filtering step may better ensure that the subsequent processing focuses on relevant and informative data. The selected pictures may then be processed by 2D image encoders. The picture encoder 217 may be configured to perform PV to BEV transformation 410. The picture encoder 217 may use intrinsic and extrinsic parameters of each SV pictures 402 as well as crowd-source pre-processed priors 310 to project to BEV space. The picture encoder 217 may extract meaningful features and representations from the 2D images. The ML system 216 may generate a 3D point cloud corresponding to the intended travel trajectory of the vehicle by performing a 3D reconstruction on the plurality of relevant pictures 406. The ML system 216 may combine the 2D object detections with the depth information from the point cloud. This integration may allow the ML system 216 to project the 2D detections into the 3D space, accurately determining the 3D locations (coordinates) of the detected static road objects in the real world.

The 3D point cloud 404 may provide a more complete representation of objects, leading to better detection performance, even in challenging scenarios. While camera performance may degrade in bad weather, the LiDAR-like modality may still provide reliable information.

The disclosed techniques offer several advantages for autonomous driving tasks of the vehicle assistance system. In one non-limiting example, the feature space, such as BEV feature map 412, may provide a comprehensive and detailed representation of the environment in a BEV perspective. In other words, the ML system 216 may capture a wide range of information, from road geometry to object locations and object attributes. A rich feature space enables the ML system 216 to be applied to various downstream tasks of the vehicle assistance system, such as, but not limited to, object detection, semantic segmentation, and motion prediction. By having access to a detailed information, the ML system 216 may make more accurate and informed decisions. In an aspect, the disclosed techniques may better ensure that the predictions of the ML system 216 are smooth and consistent over time. Such consistency may be important for tasks like motion prediction, where accurate estimates of future object trajectories may also be important.

By providing reliable and consistent estimates, the vehicle assistance system may make more informed decisions, such as, but not limited to, when to brake, accelerate, or change lanes.

In the disclosed implementation, the techniques may be robust to severe occlusions, which may be common in real-world driving scenarios. In other words, the ML system 216 may still make accurate predictions even when objects are partially or fully obscured by other objects or environmental factors.

FIG. 5 illustrates transformations from panoramic to Perspective View (PV) pictures, in accordance with the techniques of this disclosure. Street-level panoramas may essentially be 360-degree pictures captured at ground level. The street-level panoramas (e.g. panoramic pictures 502) may provide a comprehensive view of the environment surrounding vehicle 102, including, but not limited to, roads, buildings, and other objects. Equirectangular projection is a common projection technique that may be used for panoramic pictures 502. The equirectangular projection may map a spherical picture onto a rectangular plane, improving storage and processing of pictures. The panoramic pictures 502 may cover a full 360 degrees horizontally and 180 degrees vertically, providing a complete view of the scene. GPS coordinates (latitude and longitude) may pinpoint the exact location where a particular panoramic picture 502 was captured. The disclosed techniques may assign geographic coordinates to the panoramic pictures 502, allowing the panoramic pictures 502 to be accurately placed on a map.

GPS coordinates may help the ML system 216 to analyze the spatial relationships between different panoramic pictures 502, such as proximity, orientation, and overlap. By collecting a series of panoramic pictures 502 with corresponding GPS coordinates, the ML system 216 may reconstruct the trajectory of the vehicle 102.

In an aspect, to sample N panoramic pictures 502 within a 150 m radius along a trajectory of the vehicle 102, the ML system 216 may perform the following steps. In an aspect, the ML system 216 may continuously record the GPS coordinates of the vehicle 102 as the vehicle 102 moves.

At regular intervals or when specific conditions are met (e.g., significant changes in the environment), the ML system 216 may fetch a 360-degree panoramic pictures 502 from Mapping APIs. The ML system 216 may select panoramic pictures 502 that are within a 150 m radius of each other. The ML system 216 may select panoramic pictures 502 captured within a specific time interval. The ML system 216 may select panoramic pictures 502 based on the presence of specific features (e.g., intersections, landmarks). Once the ML system 216 has a collection of georeferenced panoramic pictures 502, the ML system 216 may, for example, display the panoramic pictures 502 on an interactive map, allowing drivers to explore the environment virtually. The ML system 216 may use the panoramic pictures 502 to train models, such as, but not limited to, deep learning model 220 for tasks like object detection, semantic segmentation, and scene understanding.

In an aspect, the following equations may convert pixel coordinates (u, v) in an equirectangular panoramic picture 502 to spherical coordinates (θ, φ) on sphere 504.

In an aspect, an equirectangular projection maps a spherical surface onto a rectangular plane. The proposed techniques are like unwrapping sphere 504 and laying the sphere 504 flat. While this projection may distort distances and areas, this projection may be used for panoramic pictures 502 because this projection is simple to implement and understand.

Spherical coordinates are a way to represent points in 3D space using two angles (θ, φ) and a radius (ρ). In this case, the ML system 216 may only be concerned with the angles, as the radius is implied by the surface of the sphere 504. θ (Theta) is the horizontal angle, measured in radians, from the positive x-axis. θ ranges from 0 to 2π.

φ (Phi) is the vertical angle, measured in radians, from the positive z-axis. φ ranges from −π/2 to π/2.

The horizontal angle may be represented by the following equation (1):

$$θ = 2 π ( \frac{u}{W} ) \qquad ( 1 )$$

The equation (1) maps the horizontal pixel coordinate u to a horizontal angle θ. The range of u is from 0 to W−1, so dividing by W normalizes u to a value between 0 and 1. Multiplying by 2π scales this value to the full range of horizontal angles.

The vertical angle may be represented by the following equation (2):

$$ϕ = π ( \frac{v}{H} - 0.5 ) \qquad ( 2 )$$

The equation (2) maps the vertical pixel coordinate v to a vertical angle φ. The range of v is from 0 to H−1, so dividing by H normalizes it to a value between 0 and 1. Multiplying by n scales this value to the range from 0 to π. Subtracting 0.5 shifts the range to −π/2 to π/2, which corresponds to the vertical angle range in spherical coordinates. The task of converting a set of 360-degree equirectangular panoramic pictures 502 into multiple perspective view pictures 506 is akin to simulating different camera viewpoints within the panoramic scene. Advantageously, the equirectangular panoramic pictures 502 are panoramic pictures that capture a 360-degree view of a scene. In an aspect, the equirectangular panoramic pictures 502 may be represented as a rectangular picture where the horizontal axis corresponds to the azimuth angle, and the vertical axis corresponds to the elevation angle.

A perspective view is a projection of a 3D scene onto a 2D picture plane, simulating the way a camera captures pictures. Furthermore, the perspective view may be characterized by a specific field of view (FOV), yaw angle, and pitch angle.

In an aspect, the n function may be responsible for projecting a point from the spherical coordinate system (used in equirectangular panoramic pictures 502) to a point on the perspective view picture plane. The n function may take as input the spherical coordinates (θ, φ) of a point on the sphere 504 and the desired perspective view parameters (yaw, pitch, FOV) and may output the corresponding pixel coordinates (u, v) in the perspective view picture 506. Extraction of perspective views may be represented by the following equation (3):

$${I}_{ij} = π ( {ε}_{i} , yaw = \frac{2 π}{T} j , fov = FOV ) \qquad ( 3 )$$

Next, for each equirectangular panoramic picture 502 (Iᵢⱼ) the ML system 216 may iterate over the desired number of perspective views T. For each perspective view j, the ML system 216 may calculate the yaw angle represented by equation (4) below. The ML system 216 may set the pitch angle to 0 (assuming a horizontal view). The ML system 216 may set the field of view FOV to the desired value.

In an aspect, for each pixel (u, v) in the desired perspective view picture 506, the ML system 216 may calculate the corresponding spherical coordinates (θ, φ) using the inverse projection of the perspective view parameters. The ML system 216 may use the π function to map (θ, φ) to the pixel coordinates (u′, v′) in the equirectangular panoramic picture 502. The ML system 216 may sample the pixel value at (u′, v′) in the equirectangular panoramic pictures 502 and may assign the value to the pixel (u, v) in the perspective view picture 506.

Yaw refers to the horizontal rotation of a camera or sensor. In the context of equirectangular panoramic pictures 502 and perspective view pictures 506, yaw determines the direction the camera is pointing.

Yaw may be represented by the following equation (4):

$$Yaw = \frac{2 π j}{T} \qquad ( 4 )$$

where j represents index of the perspective view picture 506, ranging from 0 to T−1,
T represents total number of perspective view pictures 506,
2π represents a full 360-degree rotation.
The equation (4) may better ensure that the yaw angle is evenly distributed across the entire 360-degree range, allowing ML system 216 to capture a complete view of the scene from different angles.

FOV defines the angular extent of the scene that is visible in the perspective view picture 506. A larger FOV may capture a wider area, while a smaller FOV may focus on a narrower region. In an aspect, perspective view pictures 506 may be generated by simulating the view of a camera placed at different positions and orientations within the 360-degree panoramic scene. Perspective view picture 506 may be similar to taking a picture of a landscape from different angles and distances.

In an aspect, by varying the yaw angle and FOV, the ML system 216 may generate a series of perspective view pictures 506 that cover the entire 360-degree panorama. As the yaw angle increases, the orientation of the camera may rotate horizontally, allowing the ML system 216 to capture different parts of the scene. The FOV may determine the width of the picture captured by the camera. A wider FOV may capture more of the scene, while a narrower FOV may focus on a specific region.

In spherical coordinates, a point in 3D space may be defined by three parameters: ρ (rho), θ, and φ. ρ is the radial distance from the origin to the point. θ is the azimuthal angle, measured from the positive x-axis in the xy-plane. φ is the polar angle, measured from the positive z-axis. In Cartesian coordinates, a point in 3D space is defined by three orthogonal coordinates: x, y, and z. X is the distance along the x-axis. y is the distance along the y-axis. Z is the distance along the z-axis.

In the context of transformation from spherical to cartesian coordinates and considering the specific case of sphere 504 with radius 1 (ρ=1), given a point in spherical coordinates (ρ, θ, φ), ML system 216 may convert the point to Cartesian coordinates (x, y, z) using the following simplified equations (5), (6) and (7):

$$x = cos ( ϕ ) cos ( θ ) \qquad ( 5 )$$

$$y = cos ( ϕ ) sin ( θ ) \qquad ( 6 )$$

$$z = sin ( ϕ ) \qquad ( 7 )$$

In an aspect, the angle θ may represent different perspective views of the sphere 504. By adding multiples of 2π to θ, the ML system 216 may essentially rotate the sphere 504 around the z-axis, generating different viewpoints. For instance, for the jth perspective view picture, θ may be represented using the following equation (8):

$${θ}^{′} = θ + \frac{2 π j}{T} \qquad ( 8 )$$

In other words, for each value of j, the ML system 216 may get a different perspective view of the sphere 504, with the same polar angle φ but a different azimuthal angle θ. Considering a sphere centered at the origin, the angle φ determines the latitude, while the angle θ determines the longitude. By varying these angles, the ML system 216 may reach any point on the surface of the sphere 504. The Cartesian coordinates (x, y, z) specify the exact location of that point in 3D space. Perspective projection (u′, v′) may be a 2D representation of a 3D point, as the point would appear in a photograph or on a screen. The coordinates (u′, v′) represent the horizontal and vertical position of the projected point on the picture plane. Cartesian (x′, y′, z) to perspective projection may be represented by the following equations (9)-(11):

$${x}^{′} = cos ( ϕ ) cos ( {θ}^{′} ) \qquad ( 9 )$$

$${y}^{′} = cos ( ϕ ) sin ( {θ}^{′} ) \qquad ( 10 )$$

$$z = sin ( ϕ ) \qquad ( 11 )$$

The final perspective projection may be represented by the following equation (12):

$${I}_{ij} = ( {u}^{′} , {v}^{′} ) \qquad ( 12 )$$

Furthermore, u and v may be represented by the equations (13) and (14):

$${u}^{′} = f \frac{{x}^{′}}{{z}^{′}} \qquad ( 13 )$$

$${v}^{′} = f \frac{{y}^{′}}{{z}^{′}} \qquad ( 14 )$$

where:
u′ and v′ are the coordinates of the projected point on the picture plane;
f is the focal length of the camera, a constant that determines the field of view;
x, y, z are the Cartesian coordinates of the 3D point.

Geometric interpretation can be explained with an example of a pinhole camera where light rays from a 3D point converge at a point on the picture plane. The distance from the pinhole to the image plane is the focal length f. The position of the projected point on the image plane depends on the ratio of its distance from the pinhole (z) to its horizontal and vertical distances (x and y).

Dividing by z′ simulates the perspective effect, where objects farther away appear smaller. The intersection of the light ray with the picture plane determines the projected point's coordinates. The z′ value scales the projection to account for distance.

In this case, the equation (12) means that the intensity of the pixel at location (i, j) in the image is determined by the projected point's coordinates (u′, v′).

In an aspect, predictions in regions with gradually changing saliency are more likely to have consistent confidence levels.

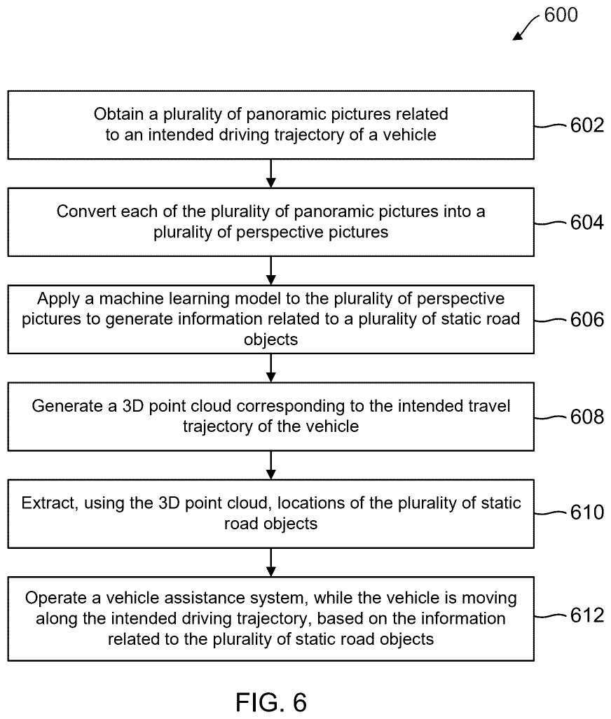

FIG. 6 is a flowchart illustrating an example method for enhancing perception range of a computer vision system, in accordance with the techniques of this disclosure. Although described with respect to computing system 200 (FIG. 2), it should be understood that other devices may be configured to perform a method similar to that of FIG. 6.

In this example, ML system 216 may initially obtain, prior to driving, a plurality of panoramic pictures related to an intended driving trajectory of the vehicle 102 (602). In the context of 3D object detection, pre-processed panoramas (also referred to herein as “panoramic pictures”) may provide a more detailed understanding of the static environment, extending the perception range beyond the immediate sensor view. The ML system 216 may convert each of the plurality of panoramic pictures into a plurality of perspective pictures (604). Perspective picture 306 may be a 2D picture with a specific field of view, simulating what a camera would capture from a particular viewpoint within the panorama, as described herein. Next, the ML system 216 may apply a machine learning model to the plurality of perspective pictures to generate information related to a plurality of static road objects (e.g., pre-processed priors) (606). In an aspect, the pre-processed priors may be used to guide the detection of static objects in real-time sensor data, improving accuracy and reducing false positives.

The ML system 216 may generate a 3D point cloud corresponding to the intended travel trajectory of the vehicle by performing a 3D reconstruction on the plurality of perspective pictures (608). In an example, 3D reconstruction to generate the 3D point cloud using the SfM/SLAM (Simultaneous Localization And Mapping) pipeline 222 may enable a better understanding of the geometry of the scene and object locations, aiding the vehicle assistance system in tasks like obstacle avoidance and navigation of the vehicle 102. Next, the ML system 216 may extract, using the 3D point cloud, locations of the plurality of static road objects (610). As noted above, the 3D locations and features of static objects may be used to track the static objects over time and predict future positions of these objects. In accordance with the techniques of the present disclosure, the ML system 216 may operate a vehicle assistance system, while the vehicle 102 is moving along the intended driving trajectory, based on the information related to the plurality of static road objects and the locations of the plurality of static road objects (612). In an aspect, a vehicle assistance system may employ an SV camera system may consist of four fisheye SV cameras 130 mounted on the corners of the vehicle 102, providing a 360-degree view of the surroundings. In other words, the ML system 216 may capture a wide range of information, from road geometry to object locations and object attributes. A rich feature space enables the ML system 216 to be applied to various downstream tasks of vehicle assistance system, such as, but not limited to, object detection, semantic segmentation, and motion prediction.

The following numbered clauses illustrate one or more aspects of the devices and techniques described in this disclosure.
Clause 1. A method for enhancing perception range of a computer vision system comprising: obtaining a plurality of panoramic pictures related to an intended driving trajectory of a vehicle; converting each of the plurality of panoramic pictures into a plurality of perspective pictures; applying one or more machine learning models to the plurality of perspective pictures to generate information related to a plurality of static road objects; generating a 3D point cloud corresponding to the intended driving trajectory of the vehicle, including performing a 3D reconstruction on the plurality of perspective pictures; extracting, using the 3D point cloud, locations of the plurality of detected static road objects; and operating a vehicle assistance system, while the vehicle is moving along the intended driving trajectory, based on the information related to the plurality of static road objects and the locations of the plurality of static road objects.
Clause 2. The method of clause 1, wherein operating the vehicle assistance system comprises: obtaining a plurality of Surround View (SV) pictures from one or more sensors of the vehicle while driving; and generating, based on the 3D point cloud, the information related to the plurality of static road objects obtained from pre-processed priors, and the plurality of SV pictures obtained while diving, a Bird's Eye View (BEV) feature map representing an environment surrounding the vehicle.
Clause 3. The method of clause 2, wherein generating the BEV feature map comprises: extracting one or more visual features from the plurality of SV pictures and from the information related to the plurality of static road objects obtained from pre-processed priors; and extracting one or more geometric features from the 3D point cloud.
Clause 4. The method of clause 2, wherein generating the BEV feature map further comprises: generating the BEV feature map using a first encoder configured to perform a Perspective View (PV) to BEV transformation and using a second encoder configured to perform 3D to BEV transformation.
Clause 5. The method of clause 4, wherein the first encoder comprises a 2D backbone network and wherein the second encoder comprises a 3D backbone network.
Clause 6. The method of any of clauses 1-5, wherein performing the 3D reconstruction on the plurality of perspective pictures comprises: performing the 3D reconstruction on the plurality of perspective pictures using Structure-from-Motion (SfM) techniques.
Clause 7. The method of any of clauses 1-6, wherein the plurality of static road objects includes at least traffic signs, traffic lights, and lane markings.
Clause 8. The method of any of clauses 1-7, wherein the one or more machine learning models comprises an object detection model and wherein applying the one or more machine learning models to the plurality of perspective pictures comprises detecting one or more of the plurality of static road objects in the plurality of perspective pictures using the object detection model.
Clause 9. A system for enhancing perception range of a computer vision system, the system comprising: a memory for storing a plurality of panoramic pictures; and processing circuitry in communication with the memory, wherein the processing circuitry is configured to: obtain the plurality of panoramic pictures related to an intended driving trajectory of a vehicle; convert each of the plurality of panoramic pictures into a plurality of perspective pictures; apply one or more machine learning models to the plurality of perspective pictures to generate information related to a plurality of static road objects; generate a 3D point cloud corresponding to the intended driving trajectory of the vehicle, including performing a 3D reconstruction on the plurality of perspective pictures; extract, using the 3D point cloud, locations of the plurality of detected static road objects; and operate a vehicle assistance system, while the vehicle is moving along the intended driving trajectory, based on the information related to the plurality of static road objects and the locations of the plurality of static road objects.
Clause 10. The system of clause 9, wherein the processing circuitry configured to operate the vehicle assistance system is further configured to: obtain a plurality of Surround View (SV) pictures from one or more sensors of the vehicle while driving; and generate, based on the 3D point cloud, the information related to the plurality of static road objects obtained from pre-processed priors, and the plurality of SV pictures obtained while diving, a Bird's Eye View (BEV) feature map representing an environment surrounding the vehicle.
Clause 11. The system of clause 10, wherein the processing circuitry configured to generate the BEV feature map is further configured to: extract one or more visual features from the plurality of SV pictures and from the information related to the plurality of static road objects obtained from pre-processed priors; and extract one or more geometric features from the 3D point cloud.
Clause 12. The system of clause 10, wherein the processing circuitry configured to generate the BEV feature map is further configured to: generate the BEV feature map using a first encoder configured to perform a Perspective View (PV) to BEV transformation and using a second encoder configured to perform 3D to BEV transformation.
Clause 13. The system of clause 12, wherein the first encoder comprises a 2D backbone network and wherein the second encoder comprises a 3D backbone network.
Clause 14. The system of any of clauses 9-13, wherein the processing circuitry configured to perform the 3D reconstruction on the plurality of perspective pictures is further configured to: perform the 3D reconstruction on the plurality of perspective pictures using Structure-from-Motion (SfM) techniques.
Clause 15. The system of any of clauses 9-14, wherein the plurality of static road objects includes at least traffic signs, traffic lights, and lane markings.
Clause 16. The system of any of clauses 9-15, wherein the one or more machine learning models comprises an object detection model and wherein applying the one or more machine learning models to the plurality of perspective pictures comprises detecting one or more of the plurality of static road objects in the plurality of perspective pictures using the object detection model.
Clause 17. Non-transitory computer-readable storage media having instructions encoded thereon, the instructions configured to cause processing circuitry to: obtain a plurality of panoramic pictures related to an intended driving trajectory of a vehicle; convert each of the plurality of panoramic pictures into a plurality of perspective pictures; apply one or more machine learning models to the plurality of perspective pictures to generate information related to a plurality of static road objects; generate a 3D point cloud corresponding to the intended driving trajectory of the vehicle, including performing a 3D reconstruction on the plurality of perspective pictures; extract, using the 3D point cloud, locations of the plurality of detected static road objects; and operate a vehicle assistance system, while the vehicle is moving along the intended driving trajectory, based on the information related to the plurality of static road objects and the locations of the plurality of static road objects.
Clause 18. The storage media of clause 17, wherein the instructions configured to cause the processing circuitry to operate the vehicle assistance system are further configured to: obtain a plurality of Surround View (SV) pictures from one or more sensors of the vehicle while driving; and generate, based on the 3D point cloud, the information related to the plurality of static road objects obtained from pre-processed priors, and the plurality of SV pictures obtained while diving, a Bird's Eye View (BEV) feature map representing an environment surrounding the vehicle.
Clause 19. The storage media of clause 18, wherein the instructions configured to cause the processing circuitry to generate the BEV feature map are further configured to: extract one or more visual features from the plurality of SV pictures and from the information related to the plurality of static road objects obtained from pre-processed priors; and extract one or more geometric features from the 3D point cloud.
Clause 20. The storage media of clause 18, wherein the instructions configured to cause the processing circuitry to generate the BEV feature map are further configured to: generate the BEV feature map using a first encoder configured to perform a Perspective View (PV) to BEV transformation and using a second encoder configured to perform 3D to BEV transformation.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules or units configured for encoding and decoding or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for enhancing perception range of a computer vision system, the method comprising:
obtaining a plurality of panoramic pictures related to an intended driving trajectory of a vehicle;
converting each of the plurality of panoramic pictures into a plurality of perspective pictures;
applying one or more machine learning models to the plurality of perspective pictures to generate information related to a plurality of static road objects;
generating a 3D point cloud corresponding to the intended driving trajectory of the vehicle, including performing a 3D reconstruction on the plurality of perspective pictures;
extracting, using the 3D point cloud, locations of the plurality of detected static road objects; and
operating a vehicle assistance system, while the vehicle is moving along the intended driving trajectory, based on the information related to the plurality of static road objects and the locations of the plurality of static road objects.

2. The method of claim 1, wherein operating the vehicle assistance system comprises:
obtaining a plurality of Surround View (SV) pictures from one or more sensors of the vehicle while driving; and
generating, based on the 3D point cloud, the information related to the plurality of static road objects obtained from pre-processed priors, and the plurality of SV pictures obtained while diving, a Bird's Eye View (BEV) feature map representing an environment surrounding the vehicle.

3. The method of claim 2, wherein generating the BEV feature map comprises:
extracting one or more visual features from the plurality of SV pictures and from the information related to the plurality of static road objects obtained from pre-processed priors; and
extracting one or more geometric features from the 3D point cloud.

4. The method of claim 2, wherein generating the BEV feature map further comprises:
generating the BEV feature map using a first encoder configured to perform a Perspective View (PV) to BEV transformation and using a second encoder configured to perform 3D to BEV transformation.

5. The method of claim 4, wherein the first encoder comprises a 2D backbone network and wherein the second encoder comprises a 3D backbone network.

6. The method of claim 1, wherein performing the 3D reconstruction on the plurality of perspective pictures comprises:
performing the 3D reconstruction on the plurality of perspective pictures using Structure-from-Motion (SfM) techniques.

7. The method of claim 1, wherein the plurality of static road objects includes at least traffic signs, traffic lights, and lane markings.

8. The method of claim 1, wherein the one or more machine learning models comprises an object detection model and wherein applying the one or more machine learning models to the plurality of perspective pictures comprises detecting one or more of the plurality of static road objects in the plurality of perspective pictures using the object detection model.

9. A system for enhancing perception range of a computer vision system, the system comprising:
a memory for storing a plurality of panoramic pictures; and
processing circuitry in communication with the memory, wherein the processing circuitry is configured to:
obtain the plurality of panoramic pictures related to an intended driving trajectory of a vehicle;
convert each of the plurality of panoramic pictures into a plurality of perspective pictures;
apply one or more machine learning models to the plurality of perspective pictures to generate information related to a plurality of static road objects;
generate a 3D point cloud corresponding to the intended driving trajectory of the vehicle, including performing a 3D reconstruction on the plurality of perspective pictures;
extract, using the 3D point cloud, locations of the plurality of detected static road objects; and
operate a vehicle assistance system, while the vehicle is moving along the intended driving trajectory, based on the information related to the plurality of static road objects and the locations of the plurality of static road objects.

10. The system of claim 9, wherein the processing circuitry configured to operate the vehicle assistance system is further configured to:
obtain a plurality of Surround View (SV) pictures from one or more sensors of the vehicle while driving; and
generate, based on the 3D point cloud, the information related to the plurality of static road objects obtained from pre-processed priors, and the plurality of SV pictures obtained while diving, a Bird's Eye View (BEV) feature map representing an environment surrounding the vehicle.

11. The system of claim 10, wherein the processing circuitry configured to generate the BEV feature map is further configured to:
extract one or more visual features from the plurality of SV pictures and from the information related to the plurality of static road objects obtained from pre-processed priors; and
extract one or more geometric features from the 3D point cloud.

12. The system of claim 10, wherein the processing circuitry configured to generate the BEV feature map is further configured to:
generate the BEV feature map using a first encoder configured to perform a Perspective View (PV) to BEV transformation and using a second encoder configured to perform 3D to BEV transformation.

13. The system of claim 12, wherein the first encoder comprises a 2D backbone network and wherein the second encoder comprises a 3D backbone network.

14. The system of claim 9, wherein the processing circuitry configured to perform the 3D reconstruction on the plurality of perspective pictures is further configured to:
perform the 3D reconstruction on the plurality of perspective pictures using Structure-from-Motion (SfM) techniques.

15. The system of claim 9, wherein the plurality of static road objects includes at least traffic signs, traffic lights, and lane markings.

16. The system of claim 9, wherein the one or more machine learning models comprises an object detection model and wherein applying the one or more machine learning models to the plurality of perspective pictures comprises detecting one or more of the plurality of static road objects in the plurality of perspective pictures using the object detection model.

17. Non-transitory computer-readable storage media having instructions encoded thereon, the instructions configured to cause processing circuitry to:
obtain a plurality of panoramic pictures related to an intended driving trajectory of a vehicle;
convert each of the plurality of panoramic pictures into a plurality of perspective pictures;
apply one or more machine learning models to the plurality of perspective pictures to generate information related to a plurality of static road objects;
generate a 3D point cloud corresponding to the intended driving trajectory of the vehicle, including performing a 3D reconstruction on the plurality of perspective pictures;
extract, using the 3D point cloud, locations of the plurality of detected static road objects; and
operate a vehicle assistance system, while the vehicle is moving along the intended driving trajectory, based on the information related to the plurality of static road objects and the locations of the plurality of static road objects.

18. The storage media of claim 17, wherein the instructions configured to cause the processing circuitry to operate the vehicle assistance system are further configured to:
obtain a plurality of Surround View (SV) pictures from one or more sensors of the vehicle while driving; and
generate, based on the 3D point cloud, the information related to the plurality of static road objects obtained from pre-processed priors, and the plurality of SV pictures obtained while diving, a Bird's Eye View (BEV) feature map representing an environment surrounding the vehicle.

19. The storage media of claim 18, wherein the instructions configured to cause the processing circuitry to generate the BEV feature map are further configured to:
extract one or more visual features from the plurality of SV pictures and from the information related to the plurality of static road objects obtained from pre-processed priors; and
extract one or more geometric features from the 3D point cloud.

20. The storage media of claim 18, wherein the instructions configured to cause the processing circuitry to generate the BEV feature map are further configured to:
generate the BEV feature map using a first encoder configured to perform a Perspective View (PV) to BEV transformation and using a second encoder configured to perform 3D to BEV transformation.
